(19) United States
(12) Patent Application Publication
(10) Pub. No.: US 2026/0360991 A1
(43) Pub. Date: Nov. 12, 2026

(54) INSTALLATION METHOD FOR RADIO WAVE CONTROL PLATE AND COMMUNICATION SYSTEM

(71) Applicant: KYOCERA Corporation, Kyoto-shi, Kyoto (JP)

(72) Inventors: Kyohei SHIRASAWA, Yokohama-shi, Kanagawa (JP); Takuya HOTAKA, Yokohama-shi, Kanagawa (JP); Nobuki HIRAMATSU, Yokohama-shi, Kanagawa (JP); Takafumi UEHAMA, Fujisawa-shi, Kanagawa (JP); Hiromichi YOSHIKAWA, Yokohama-shi, Kanagawa (JP)

(21) Appl. No.: 19/139,897

(22) PCT Filed: Dec. 7, 2023
(86) PCT No.: PCT/JP2023/043781

§ 371 Date: Jun. 17, 2025

(30) Foreign Application Priority Data
Dec. 27, 2022 (JP) 2022-210712
Jul. 3, 2023 (JP) 2023-109586

(51) Int. Cl. H01Q 15/10; H01Q 15/12; H01Q 15/14; H04B 7/145

(52) U.S. Cl. CPC H01Q 15/10; H01Q 15/12; H01Q 15/14; H04B 7/145

(57) ABSTRACT

Provided is an installation method for a radio wave control plate set between a base station and a terminal device. The radio wave control plate provided with a phase gradient in a first direction is installed at a position away from the base station in a second direction perpendicular to the first direction.

### TECHNICAL FIELD

The present disclosure relates to an installation method for a radio wave control plate and a communication system.

### BACKGROUND OF INVENTION

When high-speed communication is performed in a collective housing such as an apartment building, a wired connection using an optical line or the like, or a fixed wireless access (FWA) utilizing public LTE is utilized (e.g., Patent Document 1).

### CITATION LIST

### Patent Literature

Patent Document 1: JP 2017-17643 A

### SUMMARY

According to an embodiment of the present disclosure, there is provided an installation method for a radio wave control plate set between a base station and a terminal device. The method includes: installing the radio wave control plate provided with a phase gradient in a first direction at a position away from the base station in a second direction perpendicular to the first direction.

According to an embodiment of the present disclosure, there is provided a communication system including: a base station configured to transmit a radio wave; a radio wave control plate provided with a phase gradient in a first direction, installed at a position away from the base station in a second direction perpendicular to the first direction, and configured to receive and refract a radio wave transmitted by the base station; and a terminal device configured to receive the radio wave refracted by the radio wave control plate.

### BRIEF DESCRIPTION OF THE DRAWINGS

FIG. 1 is a diagram illustrating a configuration example of a communication system according to a first embodiment.

FIG. 2 is a diagram illustrating a configuration example of a radio wave control plate according to the first embodiment.

FIG. 3 is a diagram for explaining an installation method for the radio wave control plate according to the first embodiment.

FIG. 4 is a diagram for explaining the installation method for the radio wave control plate according to the first embodiment.

FIG. 5 is a diagram for explaining an installation method for a radio wave control plate according to a second embodiment.

FIG. 6 is a diagram for explaining the installation method for the radio wave control plate according to the second embodiment.

FIG. 7 is a diagram for explaining a radio wave refraction direction of a radio wave control plate according to a third embodiment.

FIG. 8 is a diagram for explaining electrical power of a refracted wave according to a comparative example of the third embodiment.

FIG. 9 is a diagram for explaining electrical power of a refracted wave according to the third embodiment.

FIG. 10 is a diagram for explaining an installation method for a radio wave control plate according to a fourth embodiment.

FIG. 11 is a diagram for explaining the installation method for the radio wave control plate according to the fourth embodiment.

FIG. 12 is a diagram for explaining received electrical power of a terminal device according to the fourth embodiment.

FIG. 13 is a diagram for illustrating a configuration example of a communication system according to the fifth embodiment.

### DESCRIPTION OF EMBODIMENTS

In the following, embodiments of the present invention will be described in detail with reference to the accompanying drawings. Note that the present disclosure is not limited by the embodiments, and in the following embodiments, the same reference signs are assigned to the same portions and redundant descriptions thereof will be omitted.

In the following description, an XYZ orthogonal coordinate system is set, and the positional relationship between respective portions will be described by referring to the XYZ orthogonal coordinate system. A direction parallel to an X axis in a horizontal plane is defined as an X axis direction, a direction parallel to a Y axis orthogonal to the X axis in the horizontal plane is defined as a Y axis direction, and a direction parallel to a Z axis orthogonal to the horizontal plane is defined as a Z axis direction. In the following description, the X axis direction and the Y axis direction are directions parallel to the ground, and the Z axis direction is a height direction from the ground. A plane including the X axis and the Y axis is appropriately referred to as an XY plane, a plane including the X axis and the Z axis is appropriately referred to as an XZ plane, and a plane including the Y axis and the Z axis is appropriately referred to as a YZ plane. The XY plane is parallel to the horizontal plane. The XY plane, the XZ plane, and the YZ plane are orthogonal to each other.

### First Embodiment

### Communication System

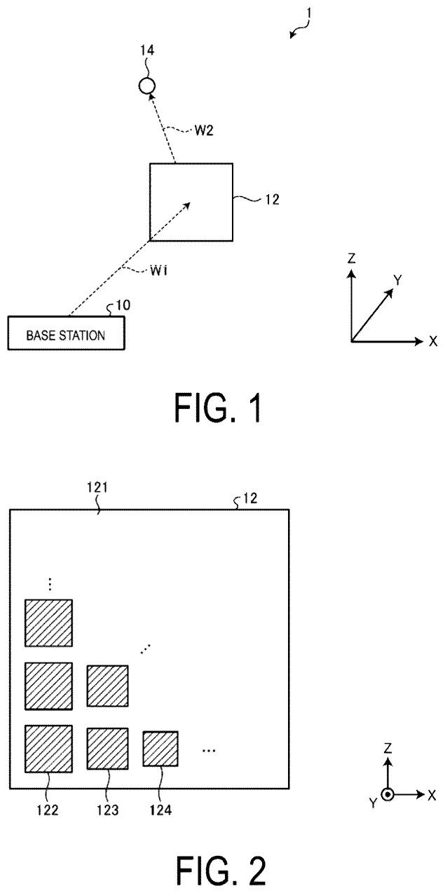

A description is given of a communication system according to a first embodiment using FIG. 1. FIG. 1 is a diagram illustrating the configuration example of the communication system according to the first embodiment.

As illustrated in FIG. 1, a communication system 1 includes a base station 10, a radio wave control plate 12, and a terminal device 14. The communication system 1 is a system that performs wireless communication using, for example, 5G (fifth generation mobile communication system) or 6G (sixth generation mobile communication system).

The base station 10 is a wireless communication device configured to perform wireless communication with the terminal device 14. The base station 10 is configured to transmit and receive a millimeter wave to perform wireless communication with the terminal device 14, for example. In the present embodiment, the base station 10 is configured to perform wireless communication with the terminal device 14 via the radio wave control plate 12.

The radio wave control plate 12 is a plate-shaped member that receives a radio wave transmitted from the base station and refracts or reflects the wave. In the present embodiment, the radio wave control plate 12 is configured to receive a radio wave W1 transmitted by the base station 10, refract the radio wave W1, and emit it as a refracted wave W2 toward the terminal device 14. Specifically, the radio wave control plate 12 is configured to refract the radio wave W1 transmitted by the base station 10 installed outdoors and emit the refracted wave W2 toward the terminal device 14 installed indoors. The radio wave control plate 12 is, for example, installed at building walls, balconies, windows. For example, the radio wave control plate 12 may be attached to a metal member by a magnet or the like so that an installation position thereof can be adjusted. The radio wave control plate 12 may be adjustably installed in a resin casing, for example. The radio wave control plate 12 may be made of, for example, a metal material that changes a phase of an incident wave.

A configuration example of the radio wave control plate according to the first embodiment will be described using FIG. 2. FIG. 2 is a diagram illustrating a configuration example of the radio wave control plate according to the first embodiment.

As illustrated in FIG. 2, the radio wave control plate 12 includes, for example, a substrate 121, unit structures 122, unit structures 123, and a unit structure 124. In the example illustrated in FIG. 2, three types of unit structures, i.e., the unit structure 122, the unit structure 123, and the unit structure 124, are included, but the present disclosure is not limited thereto.

The substrate 121 may be, for example, a dielectric substrate made of a dielectric body. The substrate 121 may have a rectangular shape, for example, but is not limited thereto. The shape of the substrate 121 may be, for example, a circle or a polygon other than a rectangle.

The unit structures 122, the unit structures 123, and the unit structure 124 may be formed on the substrate 121. The unit structures 122, the unit structures 123, and the unit structure 124 may be two-dimensionally arrayed on the substrate 121. The unit structures 122, the unit structures 123, and the unit structure 124 may have different sizes. The unit structures 122, the unit structures 123, and the unit structure 124 change the phase of the radio wave incident on the radio wave control plate 12. The unit structures 122, the unit structures 123, and the unit structure 124 may be different from each other in a frequency band and a phase change amount of the radio wave to be changed.

FIG. 2 illustrates an example of the structure of the substrate 121. In the substrate 121, the unit structures 122, the unit structures 123, and the unit structure 124 are sequentially provided along the X axis direction. In this example, the radio wave control plate 12 is configured to have a phase gradient along the X axis direction, but in general, the phase gradient also has a component in the Y axis direction. In the example illustrated in FIG. 2, the direction of the phase gradient of the radio wave control plate 12 is parallel to the ground, but the present disclosure is not limited thereto. The direction of the phase gradient of the radio wave control plate 12 may be parallel to the ground or not parallel to the ground. When the sizes and shapes of the unit structures 122, the unit structures 123, and the unit structure 124 change, the frequency band and the phase change amount of the radio wave to be refracted or reflected by the radio wave control plate 12 change.

In the present embodiment, a direction in which the phase gradient is provided may be referred to as a first direction. A direction in a horizontal plane orthogonal to the first direction may be referred to as a second direction. A direction orthogonal to the first direction and the second direction may be referred to as a third direction.

The terminal device 14 is a communication device that performs wireless communication with the base station 10 via the radio wave control plate 12. The terminal device 14 receives the radio wave transmitted by the base station 10 via the radio wave control plate 12. The terminal device 14 transmits radio waves to the base station 10 via the radio wave control plate 12. The terminal device 14 may be a mobile communication device or may be a fixed communication device. The terminal device 14 may be, for example, a relay device of radio waves or may be a smartphone.

### Installation Method for Radio Wave Control Plate

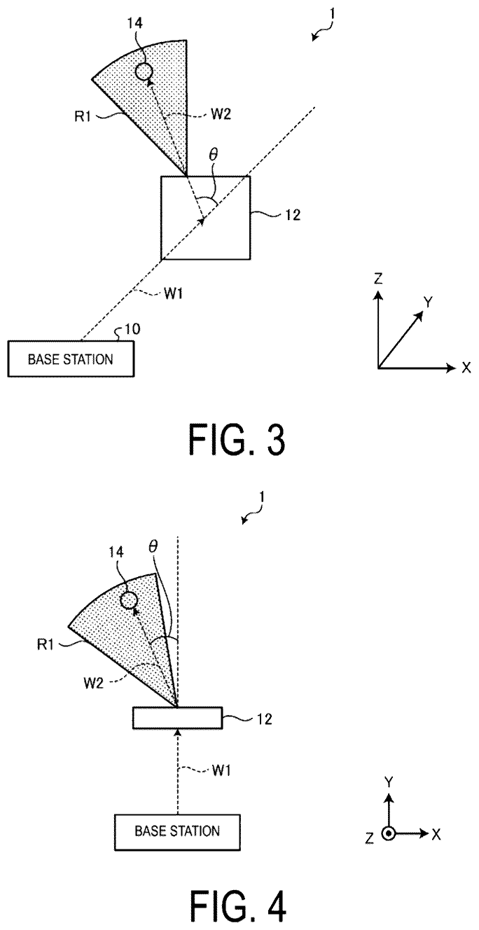

An installation method for the radio wave control plate according to the first embodiment will be described with reference to FIGS. 3 and 4. FIGS. 3 and 4 are diagrams for explaining the installation method for the radio wave control plate according to the first embodiment.

In the following description, the X axis direction corresponds to the first direction, the Y axis direction corresponds to the second direction, and the Z axis direction corresponds to the third direction, but the present disclosure is not limited thereto.

As illustrated in FIGS. 3 and 4, the half-value angle of the radio wave W1 transmitted by the base station 10 is φ and the refraction angle of the radio wave W1 of the radio wave control plate 12 is θ. When the coordinates in the X axis direction, the Y axis direction, and the Z axis direction are (X, Y, Z), the position coordinates of the base station 10 (the position coordinates of the radio wave transmission point) are (0,0,0), the position coordinates of the radio wave control plate 12 are (0, Yp, 0), and the position coordinates of the terminal device 14 are (Xu, Yu, Zu). That is, the position coordinates of the base station 10 are set as the origin. The positions of the base station 10 and the radio wave control plate 12 in the X axis direction and the Z axis direction are the same. The radio wave control plate 12 is installed at a position away from the base station 10 in the Y axis direction. That is, the base station 10 and the radio wave control plate 12 are installed at the same height from the ground. Note that, in the first embodiment, the positions of the base station 10 and the radio wave control plate 12 in the Z axis direction are the same, but the present disclosure is not limited thereto. For example, the radio wave control plate 12 is only required to be installed at a position away from the base station 10 in the Y axis direction. That is, the base station 10 and the radio wave control plate 12 may be installed at positions having different heights from the ground. The same applies hereinafter. The terminal device 14 is installed in a range R1. The range R1 is a range of θ±φ/2 and satisfies the following expression (1).

$$\begin{matrix}[ Math 1 ] & \\ θ - \frac{φ}{2} ≦ cos \{ \frac{\vec{a} \cdot \vec{b}}{\vert \vec{a} \vert \vert \vec{b} \vert} \} ≦ θ + \frac{φ}{2} & ( 1 )\end{matrix}$$

In the expression (1), a position vector a is (0, Yp, 0), and a position vector b is (Xu, Yu−Yp, Zu). In FIGS. 3 and 4, the range R1 is a range in which effective electrical power of the refracted wave W2 emitted from the radio wave control plate 12 can be obtained. That is, the radio wave control plate 12 is installed between the base station 10 and the terminal device 14 so that the terminal device 14 can obtain effective electrical power.

As described above, in the first embodiment, the radio wave control plate 12 is installed at the same height as the base station 10 in the direction perpendicular to the phase gradient, and the radio wave is refracted toward the range R1, so that the radio wave W1 transmitted by the base station 10 can be appropriately received by the terminal device 14.

In the first embodiment, even when the radio wave control plate 12 is installed at a height different from that of the base station 10 in the direction perpendicular to the phase gradient, the radio wave W1 transmitted by the base station 10 can be appropriately received by the terminal device 14 by satisfying the equation (1). Note that, in this case, the position coordinates at which the radio wave control plate 12 is installed can be (0, Yp, Zp), the position vector a can be (0, Yp, Zp), and the position vector b can be (Xu, Yu−Yp, Zu−Zp).

### Second Embodiment

A second embodiment will be described. In the second embodiment, by considering the direction of the phase gradient of the radio wave control plate 12, the radio wave W1 transmitted by the base station 10 can be more appropriately received by the terminal device 14.

### Installation Method for Radio Wave Control Plate

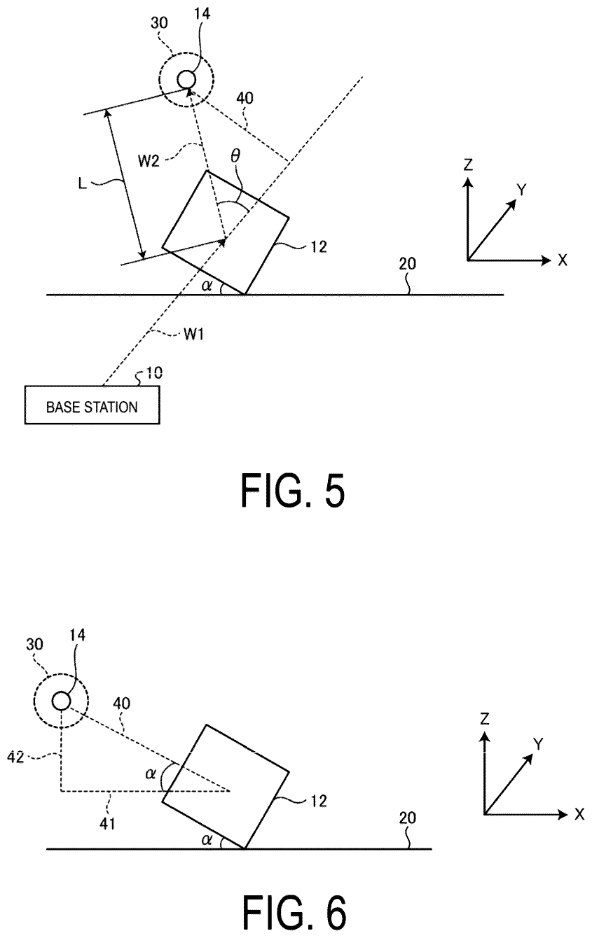

An installation method for the radio wave control plate according to the second embodiment will be described with reference to FIGS. 5 and 6. FIGS. 5 and 6 are diagrams for explaining the installation method for the radio wave control plate according to the second embodiment.

As illustrated in FIG. 5, in the second embodiment, the radio wave control plate 12 is inclined by an inclination angle α with respect to the ground 20 parallel to the XY plane. That is, the direction of the phase gradient of the radio wave control plate 12 is inclined with respect to the ground 20 so that the terminal device 14 can obtain effective electrical power.

Specifically, the distance between the radio wave control plate 12 and the terminal device 14 is set to L. In this case, the inclination angle α is set to an angle formed by a straight line 40 at which two planes of “the plane of the radio wave control plate 12” and “a plane group passing through the position coordinates of the base station 10, the position coordinates of the radio wave control plate 12, and a point inside a sphere 30 with a radius L tan (φ/2) centered on the position coordinates of the terminal device 14” intersect with the ground. The length of the straight line 40 is L sin θ.

As illustrated in FIG. 6, a distance 41 in the X direction from the radio wave control plate 12 to the terminal device 14 is L cos α. A distance 42 in the Z direction from the radio wave control plate 12 to the terminal device 14 is L sin α. In this case, the terminal device 14 is installed so that the position coordinate Xu in the X axis direction and the position coordinate Zu in the Z axis direction of the terminal device 14 satisfy the relationships of the following expressions (2) and (3), respectively.

$$\begin{matrix}[ Math 2 ] & \\ ( L sin θ ) cos α - L tan ( \frac{φ}{2} ) ≦ {X}_{u} ≦ ( L sin θ ) cos α + L tan ( \frac{φ}{2} ) & ( 2 )\end{matrix}$$

$$\begin{matrix}[ Math 3 ] & \\ ( L sin θ ) sin α - L tan ( \frac{φ}{2} ) ≦ {Z}_{u} ≦ ( L sin θ ) sin α + L tan ( \frac{φ}{2} ) & ( 3 )\end{matrix}$$

In the second embodiment, by satisfying expression (2) and expression (3), the terminal device 14 can obtain effective electrical power more appropriately.

### Third Embodiment

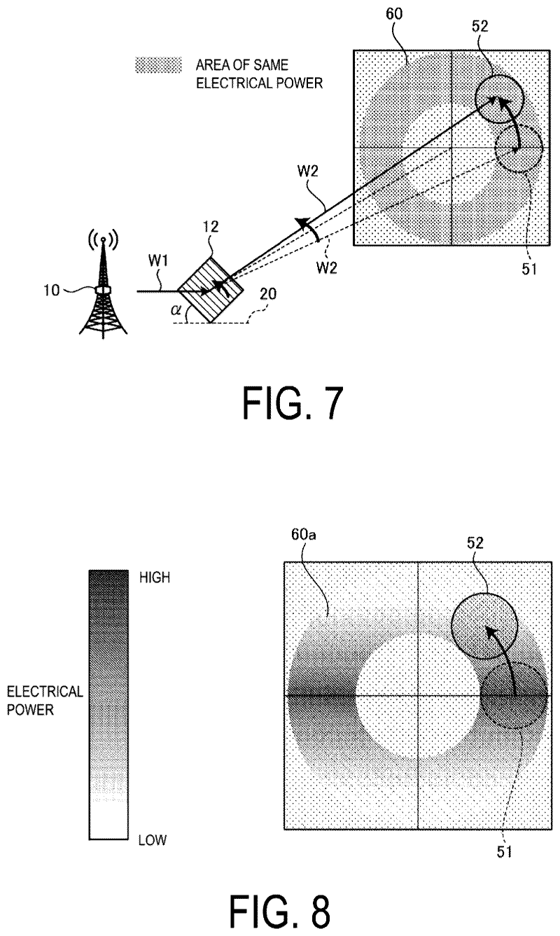

A radio wave refraction direction of a radio wave control plate according to a third embodiment will be described with reference to FIG. 7. FIG. 7 is a diagram for explaining the radio wave refraction direction of the radio wave control plate according to the third embodiment.

As illustrated in FIG. 7, by changing the inclination angle α of the direction of the phase gradient of the radio wave control plate 12 with respect to the ground 20, the refraction direction of the radio wave W1 transmitted by the base station 10 can be changed. For example, when the direction of the phase gradient of the radio wave control plate 12 is set to be horizontal to the ground 20, the radio wave control plate 12 emits the refracted wave W2 toward a position 51. For example, when the direction of the phase gradient of the radio wave control plate 12 is inclined in the direction of the arrow, the radio wave control plate 12 emits the refracted wave W2 toward a position 52. The radio wave control plate 12 can emit the refracted wave W2 to any position in an area 60 by adjusting the inclination angle α.

FIG. 8 is a diagram for explaining electrical power of a refracted wave according to a comparative example of the third embodiment. In the comparative example of the third embodiment, the radio wave control plate 12 is configured to refract either the horizontally polarized wave or the vertically polarized wave. When the radio wave control plate 12 refracts either the horizontally polarized wave or the vertically polarized wave, there is a problem in that a radio wave component in a direction perpendicular to the polarization direction cannot be refracted. For example, as illustrated in FIG. 8, when the radio wave control plate 12 is configured to refract only the horizontally polarized wave, the terminal device 14 can obtain effective electrical power when the refracted wave W2 is emitted toward the position 51. However, when the refracted wave W2 is emitted toward the position 52, the terminal device 14 may not obtain effective electrical power. Therefore, as illustrated in an area 60a, there are a position where effective electrical power is obtained and a position where effective electrical power is not obtained. Therefore, in the third embodiment, the radio wave control plate 12 is capable of refracting both of the horizontally polarized wave and the vertically polarized wave.

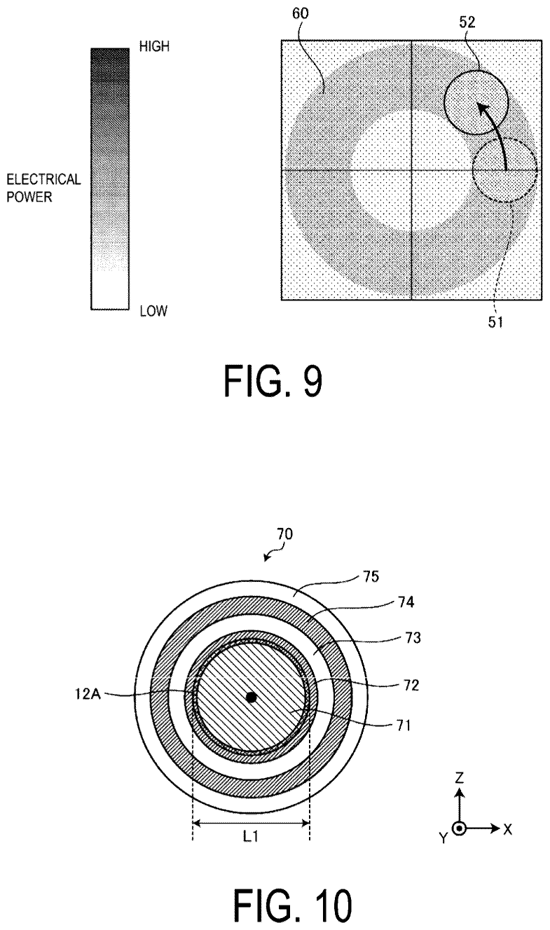

FIG. 9 is a diagram for explaining electrical power of the refracted wave according to the third embodiment. As illustrated in FIG. 9, when the radio wave control plate 12 is configured to refract both the horizontally polarized wave and the vertically polarized wave, effective electrical power can be obtained at both the position 51 and the position 52. In this case, the terminal device 14 can obtain effective electrical power at any position in the area 60.

As described above, in the third embodiment, since the radio wave control plate 12 is configured to be able to refract both the horizontally polarized wave and the vertically polarized wave, the area in which the terminal device 14 can obtain effective electrical power is enlarged. Thus, in the third embodiment, since the terminal device 14 can obtain effective electrical power even when the radio wave control plate 12 is inclined in any way, the degree of freedom in the installation of the radio wave control plate 12 can be improved.

### Fourth Embodiment

A fourth embodiment will be described. The reception power efficiency changes depending on the shape of the radio wave control plate 12. Therefore, in the fourth embodiment, the shape of the radio wave control plate 12 is changed to improve the reception power efficiency.

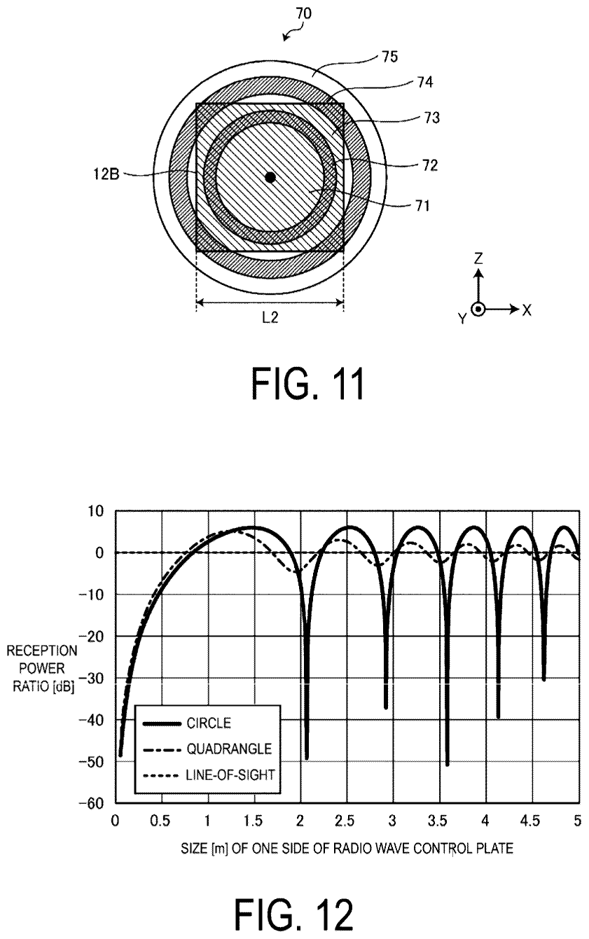

Using FIGS. 10 and 11, an installation method for a radio wave control plate according to the fourth embodiment will be described. FIGS. 10 and 11 are diagrams for explaining an installation method for the radio wave control plate according to the fourth embodiment.

In the fourth embodiment, the radio wave control plate is installed in a region defined based on a positional relationship between the base station 10, the radio wave control plate 12, and the terminal device 14. Specifically, the radio wave control plate 12 is installed in a circular Fresnel zone 70 defined based on a linear distance between the base station 10 and the radio wave control plate 12 and a linear distance between the radio wave control plate 12 and the terminal device 14.

On the Fresnel zone 70, a region in which radio waves strengthen each other is referred to as an odd-order Fresnel zone, and a region in which radio waves weaken each other is referred to as an even-order Fresnel zone. FIGS. 10 and 11 illustrate a first Fresnel zone 71, a second Fresnel zone 72, a third Fresnel zone 73, a fourth Fresnel zone 74, and a fifth Fresnel zone 75. The first Fresnel zone 71, the third Fresnel zone 73, and the fifth Fresnel zone 75 are odd-order Fresnel zones. The second Fresnel zone 72 and the fourth Fresnel zone 74 are even-order Fresnel zones. FIG. 10 illustrates a circular radio wave control plate 12A having a diametric length L1. FIG. 11 illustrates a square radio wave control plate 12B having a side length L2.

FIG. 12 is a diagram for illustrating a received electrical power of the terminal device according to the fourth embodiment. In FIG. 12, the horizontal axis represents the size [m] of one side of the radio wave control plate, and the vertical axis represents the reception power ratio [dB (decibel)] with reference to the reception power characteristic of a line-of-sight without using the radio wave control plate 12. FIG. 12 illustrates reception power characteristics of the circular radio wave control plate 12A, the quadrangular radio wave control plate 12B, and a line-of-sight without using the radio wave control plate 12. In FIG. 12, the reception power characteristic of the radio wave control plate 12A is indicated by a solid line waveform, the reception power characteristic of the radio wave control plate 12B is indicated by a chain line, and the reception power characteristic of the line-of-sight is indicated by a dotted line.

As illustrated by the waveform of the solid line, when a diameter L1 (or radius) of the radio wave control plate 12A coincides with the diameter (or radius) of the even-order Fresnel zone, the reception power ratio is extremely reduced. Therefore, it is preferable to form the radio wave control plate 12A in such a manner that the diameter L1 does not coincide with the diameter of the even-order Fresnel zone. Note that when the radio wave control plate 12A is formed in such a manner that the diameter L1 coincides with the odd-order Fresnel zone, the reception power characteristic can be improved.

As illustrated by the waveform of the chain line, the radio wave control plate 12B indicates a good reception power ratio on average regardless of a length L2 of one side. Therefore, in the fourth embodiment, it is preferable that the radio wave control plate be formed in a quadrangular shape like the radio wave control plate 12B. In the fourth embodiment, the shape of the radio wave control plate 12B is not limited to a quadrangle, and may be a polygon other than a quadrangle. When the radio wave control plate is formed in a polygonal shape as the radio wave control plate 12B, it is preferable that the radio wave control plate be disposed so as to straddle the odd-order Fresnel zone and the even-order Fresnel zone.

The radio wave control plate 12B preferably has at least the length L2 larger than the radius of the first Fresnel zone 71. It is more preferable that the radio wave control plate 12B be formed in such a manner that the length L2 is formed in a range of twice±25% of the radius of the first Fresnel zone 71. In the fourth embodiment, by setting the length L2 of the radio wave control plate 12B twice±25% of the radius of the first Fresnel zone 71, sufficient electrical power can be delivered to the terminal device 14.

As described above, in the fourth embodiment, since the radio wave control plate is formed in a polygonal shape like the radio wave control plate 12B, the received electrical power that the terminal device 14 can obtain can be stabilized. Accordingly, in the fourth embodiment, the terminal device 14 can more appropriately receive the radio wave transmitted by the base station 10.

In the fourth embodiment, by setting the length L2 of the radio wave control plate 12B to twice±25% of the radius of the first Fresnel zone 71, the electrical power that the terminal device 14 can obtain can be improved.

### Fifth Embodiment

A fifth embodiment will be described. When there are a plurality of terminal devices 14, radio waves from the base station 10 need to be refracted in a plurality of directions, and therefore there is a possibility that radio waves cannot be delivered to each of the plurality of terminal devices 14.

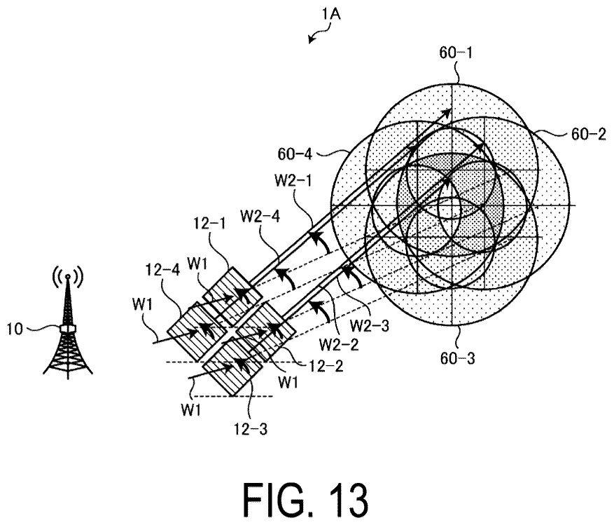

A configuration example of a communication system according to the fifth embodiment will be described with reference to FIG. 13. FIG. 13 is a diagram illustrating the configuration example of the communication system according to the fifth embodiment.

As illustrated in FIG. 13, a communication system 1A includes the base station 10, a radio wave control plate 12-1, a radio wave control plate 12-2, a radio wave control plate 12-3, and a radio wave control plate 12-4. That is, the communication system 1A includes a plurality of radio wave control plates 12. Although the example illustrated in FIG. 13 is described as including the four radio wave control plates 12 of the radio wave control plates 12-1 to 12-4, the present disclosure is not limited thereto.

The radio wave control plates 12-1 to 12-4 may be arranged at predetermined intervals. Intervals between the adjacent radio wave control plates 12 may be the same or different. The radio wave control plates 12-1 to 12-4 may be arranged in a square shape, for example. The radio wave control plates 12-1 to 12-4 may be arranged in a straight line, for example.

The radio wave control plate 12-1 refracts the radio wave W1 transmitted by the base station 10 and emits a refracted wave W2-1. The radio wave control plate 12-1 can emit the refracted wave W2-1 toward the terminal device 14 present in an area 60-1 by changing the angle of the phase gradient direction with respect to the ground.

The radio wave control plate 12-2 refracts the radio wave W1 transmitted by the base station 10 and emits a refracted wave W2-2. The radio wave control plate 12-2 can emit the refracted wave W2-2 toward the terminal device 14 present in an area 60-2 by changing the angle of the phase gradient direction with respect to the ground.

The radio wave control plate 12-3 refracts the radio wave W1 transmitted by the base station 10 and emits a refracted wave W2-3. The radio wave control plate 12-3 can emit the refracted wave W2-3 toward the terminal device 14 present in an area 60-3 by changing the angle of the phase gradient direction with respect to the ground.

The radio wave control plate 12-4 refracts the radio wave W1 transmitted by the base station 10 and emits a refracted wave W2-4. The radio wave control plate 12-4 can emit the refracted wave W2-4 toward the terminal device 14 present in an area 60-4 by changing the angle of the phase gradient direction with respect to the ground.

The radio wave control plates 12-1 to 12-4 may have the same shape, or may have different shapes. The radio wave control plates 12-1 to 12-4 may have the same refraction angle or different refraction angles.

That is, the radio wave control plates 12-1 to 12-4 are configured to emit radio waves to different areas. That is, in the fifth embodiment, by installing a plurality of radio wave control plates 12, radio waves can be delivered to a wider range.

As described above, in the fifth embodiment, by installing a plurality of radio wave control plates 12, the range in which the radio wave W1 transmitted by the base station 10 is refracted can be expanded. Thus, in the fifth embodiment, the radio wave W1 transmitted by the base station 10 can be received by a plurality of terminal devices 14.

Embodiments of the present disclosure have been described above, but the present disclosure is not limited by the contents of the embodiments. Constituent elements described above include those that can be easily assumed by a person skilled in the art, those that are substantially identical to the constituent elements, and those within a so-called range of equivalency. The constituent elements described above can be combined as appropriate. Various omissions, substitutions, or modifications of the constituent elements can be made without departing from the spirit of the above-described embodiments.

### REFERENCE SIGNS

1, 1A Communication system
10 Base station
12 Radio wave control plate
14 Terminal device
70 Fresnel zone
71 First Fresnel zone
72 Second Fresnel zone
73 Third Fresnel zone
74 Fourth Fresnel zone
75 Fifth Fresnel zone

1. An installation method for a radio wave control plate set between a base station and a terminal device, the method comprising:
installing the radio wave control plate provided with a phase gradient in a first direction at a position away from the base station in a second direction perpendicular to the first direction.

2. The installation method for a radio wave control plate according to claim 1,
wherein the radio wave control plate is installed at the same position as the base station in a third direction perpendicular to the first direction and the second direction.

3. The installation method for a radio wave control plate according to claim 1,
wherein a refraction angle θ of the radio wave control plate satisfies a following expression (1) when a position coordinate of the base station is an origin, a position vector of the radio wave control plate is a, a position vector of the terminal device is b, and a half-value angle of a radio wave transmitted by the base station is φ.
$$\begin{matrix}[ Math 1 ] & \\ θ - \frac{φ}{2} ≦ cos \{ \frac{\vec{a} \cdot \vec{b}}{\vert \vec{a} \vert \vert \vec{b} \vert} \} ≦ θ + \frac{φ}{2} & ( 1 )\end{matrix}$$

4. The installation method for a radio wave control plate according to claim 1,
wherein, when a distance between the terminal device and the radio wave control plate is L, position information of the terminal device in a first direction is Xu, and position information of the terminal device in a third direction is Zu, the radio wave control plate is installed in such a manner that an angle α of the first direction of the radio wave control plate with respect to a first plane including the first direction and the second direction satisfies the following expressions (2) and (3).
$$\begin{matrix}[ Math 2 ] & \\ ( L sin θ ) cos α - L tan ( \frac{φ}{2} ) ≦ {X}_{u} ≦ ( L sin θ ) cos α + L tan ( \frac{φ}{2} ) & ( 2 )\end{matrix}$$
$$\begin{matrix}[ Math 3 ] & \\ ( L sin θ ) sin α - L tan ( \frac{φ}{2} ) ≦ {Z}_{u} ≦ ( L sin θ ) sin α + L tan ( \frac{φ}{2} ) & ( 3 )\end{matrix}$$

5. The installation method for a radio wave control plate according to claim 4,
wherein the radio wave control plate is configured to refract a vertically polarized radio wave and a horizontally polarized radio wave.

6. The installation method for a radio wave control plate according to claim 5,
wherein the radio wave control plate is formed not to coincide with an even-order Fresnel zone among a plurality of Fresnel zones defined from position information of the base station, the radio wave control plate, and the terminal device.

7. The installation method for a radio wave control plate according to claim 6,
wherein the radio wave control plate is formed in a polygonal shape to extend over an even-order Fresnel zone and an odd-order Fresnel zone among the plurality of Fresnel zones.

8. The installation method for a radio wave control plate according to claim 7,
wherein an area of the radio wave control plate is larger than an area of a first Fresnel zone among the plurality of Fresnel zones.

9. The installation method for a radio wave control plate according to claim 8,
wherein a length of the radio wave control plate in the first direction is 75% or more and 125% or less of twice a radius of the first Fresnel zone.

10. The installation method for a radio wave control plate according to claim 9,
wherein
a plurality of the radio wave control plates are installed between the base station and the terminal device; and
each of the plurality of radio wave control plates is formed to receive a radio wave transmitted by the base station and refract the radio wave in a different direction.

11. A communication system comprising:
a base station configured to transmit a radio wave;
a radio wave control plate provided with a phase gradient in a first direction, installed at a position away from the base station in a second direction perpendicular to the first direction, and configured to receive and refract a radio wave transmitted by the base station; and
a terminal device configured to receive the radio wave refracted by the radio wave control plate.
